(19) United States
(12) Patent Application Publication
(10) Pub. No.: US 2003/0197777 A1
(43) Pub. Date: Oct. 23, 2003

(54) Beam position adjusting method and device for optical scanning apparatus

(75) Inventor: Tatsuyuki Miura, Fujisawa-shi (JP)

Correspondence Address: FOLEY AND LARDNER, SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/414,391

(22) Filed: Apr. 16, 2003

(30) Foreign Application Priority Data
Apr. 18, 2002 (JP) 2002-116211

(51) Int. Cl. B41J 2/435; B41J 2/47

(52) U.S. Cl. 347/235

(57) ABSTRACT

Even when reset during standby, an optical scanning apparatus according to the present invention enables the angles of mirror faces of galvanomirrors to be easily adjusted to reduce the time required to adjust the positions of light beams.

### CROSS-REFERENCE TO RELATED APPLICATIONS

This application is based upon and claims the benefit of priority from the prior Japanese Patent Application No. 2002-116211, filed Apr. 18, 2002, the entire contents of which are incorporated herein by reference.

### BACKGROUND OF THE INVENTION

1. Field of the Invention

The present invention relates to a beam position adjusting method and device for an optical scanning apparatus that uses light beams such as laser beams.

2. Description of the Related Art

A multibeam exposure device has been known which can be adapted for an image forming apparatus such as a high-speed digital copying apparatus or a high-speed printing apparatus and which simultaneously uses two or more light beams in order to expose a charged area of a photosensitive drum.

The multibeam exposure device has two or more semiconductor laser elements that emit respective layer beams, an optical member which sets and adjusts the diameter of each laser beam so as to correspond to a desired resolution and which sets the interval between the laser beams in a sub-scanning direction (orthogonal to an axial direction of a photosensitive drum) to a predetermined value, a polarizing device that polarizes all laser beams so as to travel in a main scanning direction (extending along the axial direction of the photosensitive drum), and an image forming lens system that guides the laser beams polarized by the polarizing device, to the charged area of the photosensitive drum to form an image, and other components.

As an optical member used for such a multibeam exposure device, galvanomirrors are used in each of which a mirror is mounted in a movable member including an electromagnetic coil so that the angle of a mirror face can be slightly varied by controlling the magnitude of a current flowing through the coil. The interval between the laser beams in the sub-scanning direction can be set at 42.3 μm with a resolution of, for example, 600 dpi by fine-tuning the angles of mirror faces of the galvanomirrors.

To adjust the interval, a laser position detecting sensor such as a photodiode are utilized. The sensor detects the positions of all laser beams. Then, on the basis of results of the detection, the interval between the lasers is adjusted.

As described above, the interval between the laser beams in the sub-scanning direction can be set at a predetermined value. At this time, in each galvanomirror, a current with a certain value flows through the electromagnetic coil. The current allows the inclination of the mirror face to be maintained at a predetermined value.

For example, in this condition, when a power source for the exposure device is turned off, a power supply to the galvanomirrors is also turned off. Thus, the angle of mirror face of each galvanomirrors is returned to a position at which the mirror is balanced owing to its own weight. Subsequently, if an exposure operation is performed to supply a current to the exposure device, the inclination of mirror face of the galvanomirror (at this instance) is markedly different from that used to carry out exposure in order to form an image because the inclination of the mirror face has already been set. Thus, much time is required for a step of making such adjustment that the inclination of the mirror face set by a reset operation of cutting off the supply of current equals the predetermined mirror face inclination used to form an image.

Further, if laser beams reflected by the mirror face do not pass through light receiving surface of the sensor, the positions of the laser beams are not detected. In this case, the inclinations of the mirror faces must be set so that the laser beams can pass through the light receiving surface of the sensor. Then, disadvantageously, more time is required to execute the above step.

### BRIEF SUMMARY OF THE INVENTION

It is an object of the present invention to provide a beam position adjusting method and device for an optical scanning apparatus which enables the angles of mirror faces of reset galvanomirrors to be easily adjusted to reduce the time required to adjust the positions of light beams.

According to an aspect of the invention, a beam position adjusting method for adjusting angles of surfaces of galvanomirrors by supplying predetermined power with respect to positions which detect positions on the sensors through which laser beams to be scanned pass so that the passage positions of the light passing through the sensors from driving control means to the galvanomirrors comprising:

storing a value of power supplied to the galvanomirrors as information on the angles of the galvanomirrors obtained while the driving control means is turned off; and

reading the value of power supplied to the galvanomirrors on the basis of the information stored within the storing and supplying a predetermined power to the galvanomirrors.

According to another aspect of the invention, an optical scanning apparatus using galvanomirrors each having a mirror face the angle of which can be changed by supplying power to the galvanomirror, the apparatus also using sensors which

detects positions on the sensors through which laser beams to be scanned pass so that the passage positions of the light passing through the sensors can be adjusted by changing the angles of mirror faces of the galvanomirrors, the apparatus comprising:

a storage section which stores the value of power supplied to the galvanomirrors as information on mirror face angles at which the galvanomirrors are located;

storage control means for causing the storage section to store the information on the angles of the mirror faces while not supplying power to the galvanomirrors; and

driving control means for reading the information on the angles of the mirror faces stored in the storage section while supplying the power to the galvanomirrors and for displacing the galvanomirrors on the basis of the information on the angles of the mirror faces.

According to still another aspect of the invention, an optical scanning apparatus comprising:

a plurality of light sources each of which emits light of a predetermined wavelength;

optical-path aligning means for positioning light beams from the respective light sources at predetermined intervals in a first direction to synthesize the light beams so that the beams appear single;

polarizing means for polarizing the light beams form the respective light sources synthesized by the optical-path aligning means so that the beams travel along a second direction orthogonal to the first direction;

displacement detecting means for detecting displacement of the optical-path aligning means with respect to the first direction by detecting at least one of the light beams from the respective light sources which are polarized by the polarizing means;

a storage section which stores the displacement of the optical-path aligning means detected by the displacement detecting means; and

a driving means for energizing the optical-path aligning means and for aligning the displacement of the optical-path aligning means so as to provide such light beams that the light beams from the respective light sources can be considered to be single.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of the invention.

FIG. 1 is a schematic view showing a configuration of a digital copying apparatus having a multibeam exposure device to which an embodiment of the present invention is applied;

FIG. 2 is a schematic view showing a multibeam exposure device incorporated into the digital copying apparatus shown in FIG. 1;

FIG. 3 is a schematic block diagram illustrating an example of a control system of the multibeam exposure device shown in FIG. 2;

FIG. 4 is an exploded perspective view illustrating a configuration of galvanomirrors incorporated into the multibeam exposure device shown in FIG. 3;

FIG. 5 is a block diagram showing a beam position detecting circuit that detects the positions of beams using a beam position detecting sensor in the multibeam exposure shown in FIG. 2;

FIG. 6 is a schematic view illustrating the characteristics of a detecting surface of the beam position detecting sensor incorporated into the multibeam exposure device shown in FIG. 2; and

FIG. 7 is a flow chart illustrating a step of adjusting the angles of galvanomirrors using the beam position detecting sensor having the detecting surface shown in FIG. 6.

### DETAILED DESCRIPTION OF THE INVENTION

An embodiment of the present invention will be described with reference to the drawings.

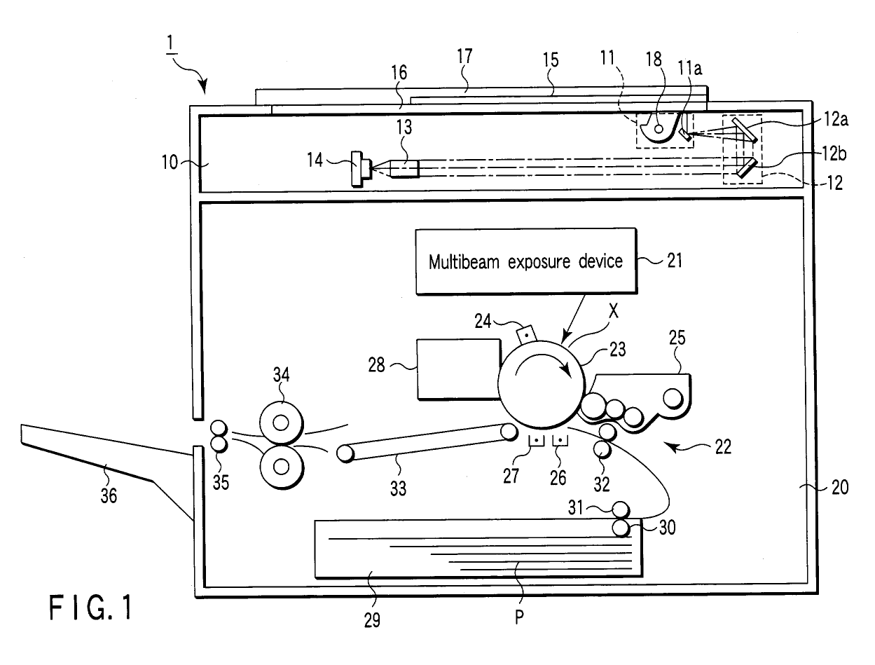

FIG. 1 schematically shows a configuration of an image forming apparatus (digital copying apparatus) using a multibeam exposure device that simultaneously uses two or more beams. The digital copying apparatus 1 has a scanner section 10 and a printer section 20.

The scanner section 10 has a first carriage 11 formed so as to be movable in the direction of an arrow in the figure, a second carriage 12 moved so as to follow the first carriage 11, an optical lens 13 that provides light from the second carriage 12 with predetermined image forming characteristics, a photoelectric converting element 14 such as a CCD sensor which photoelectrically converts the light provided with the predetermined image forming characteristics by the optical lens 13, to output an electric signal, an original table 16 that holds an original 15, an original fixing cover 17 that tightly contacts the original 15 with the original table 16, and other components.

The first carriage 11 is provided with a light source 18 that illuminates the original 15 and a mirror 11a that reflects light reflected by the original 15 illuminated by light emitted by the light source 18, toward the second carriage 12.

The second carriage 12 is provided with a mirror 12a that bends light transmitted by the mirror 11a of the first carriage 11, through 90°, and a mirror 12b that further bends light bent by the mirror 12a, through 90°.

Light reflected by the original 15 placed on the original table 16 and illuminated by the light source 18 impinges against the optical lens 13 via the mirrors 11a, 12a, and 12b as image light. The reflected light contains different levels of brightness corresponding to the presence or absence of image information in the original 15.

Image light incident on the optical lens 13 is collected on a light receiving surface of the photoelectric converting element 14 by the optical lens 13. The image light from the original 15 is sequentially collected on the photoelectric converting element 14 by moving the first carriage 11 and the second carriage 12 along the original table 16 at a relative speed ratio of 2:1. The photoelectric converting element 14 converts the image light into a digital signal corresponding to the density of the image.

The printer section 20 has a multibeam exposure device 21 and an image forming section 22 that forms an image on a recording sheet P by an electrophotographic method.

The image forming section 22 comprises a drum-shaped photosensitive member having a photosensitive layer formed on its surface, i.e. a photosensitive drum 23, a charging device 24 that applies a potential of a predetermined polarity to the surface of the photosensitive drum 23, a developing device 25 that supplies toner to a latent image formed on the surface of the photosensitive drum 23 by the multibeam exposure device 21, a transfer device 26 that applies an electric field to a toner image formed by development carried out by the developing device 25, to transfer the toner image to the recording sheet P, a separating device 27 that separates the recording paper P to which the toner image has been transferred, from the photosensitive drum 23, a cleaning device 28 that removes toner remaining on the surface of the photosensitive drum 23 after the toner image has been transferred to the sheet P, to return the potential distribution of the photosensitive drum 23 to its state prior to charging.

The charging device 24, the developing device 25, the transfer device 26, the separating device 27, and the cleaning device 28 are sequentially arranged along the direction of an arrow in which the photosensitive drum 23 is rotated. Further, laser beams from the multibeam exposure device 21 are applied to an exposure position X between the charging device 24 and the developing device 25.

An image processing section (not shown) executes, for example, edge enhancement or a half-tone-processing for half tone images on an image signal read from the original 15 by the scanner section 10, to convert this signal into a print signal. This print signal is then converted into a laser modulating signal used to vary the light intensity of laser beams emitted by a semiconductor laser element in the multibeam exposure device 21.

Laser beams from the multibeam exposure device 21 form an electrostatic latent image at the exposure position X in the photosensitive drum 23. The electrostatic latent image formed on the surface of the photosensitive drum 23 is developed using toner from the developing device 25, and is then carried to a position opposite to the transfer device 26 by rotating the photosensitive member 23. On the other hand, one recording sheet P is taken out of a sheet cassette 29 by a sheet feeding roller 30 and a separating roller 31. The sheet P is then carried to a transfer position at which the transfer device 26 and the photosensitive drum 23 are opposite each other while required timings are being adjusted by an aligning roller 32. The toner image formed on the photosensitive drum 23 is transferred to the recording sheet P at the transfer position by an electric field from the transfer device 26.

The recording sheet P to which the toner image has been transferred is separated from the photosensitive drum 23 by the separating device 27 and then guided to a fixing device 34 by a carrying device 33. The fixing device 34 then heats and presses the recording sheet P guided to the fixing device 34, to fix the electrostatically attached toner. The sheet P to which the toner is fixed is discharged to a tray 36 by a sheet discharging roller 35.

On the other hand, the photosensitive drum 23 to which the toner image has been transferred by the transfer device 26 continues to be rotated. The cleaning device 28 removes toner remaining on the surface of photosensitive drum 23 after the transfer. Furthermore, the cleaning device 28 returns the photosensitive drum 23 to its initial condition set before the potential is supplied to its surface. Then, the next image can be formed.

Continuous image formation can be accomplished by repeating the above steps.

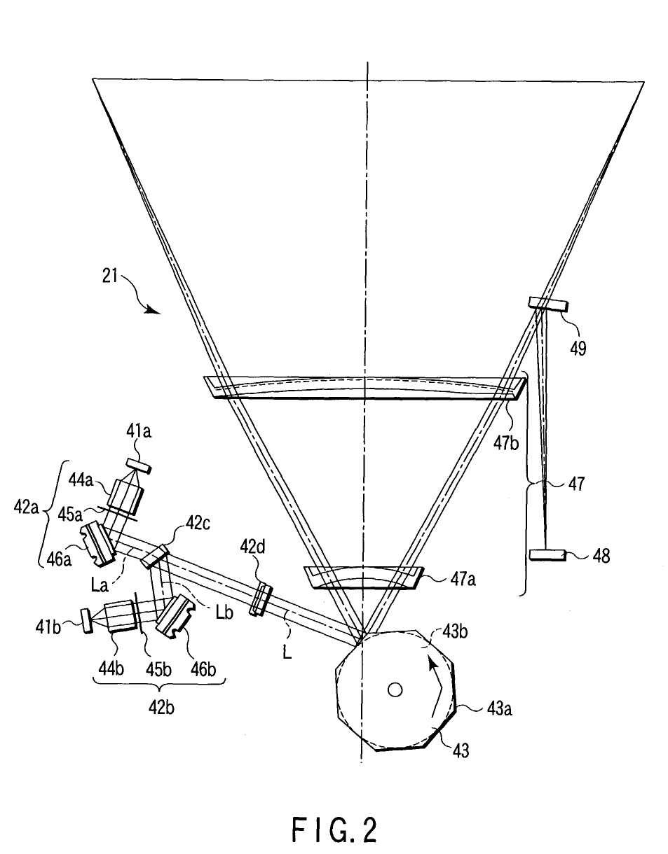

Now, with reference to FIG. 2, description will be given of an example of a multibeam exposure device incorporated into the digital copying apparatus shown in FIG. 1. FIG. 2 shows the multibeam exposure device 21 from which a housing (body frame) has been removed and some mirrors are omitted and in which optical paths of laser beams are shown on the same plane.

The multibeam exposure device 21 is provided with semiconductor laser elements 41a and 41b as a light beam generating source as shown in FIG. 2.

Laser beams La and Lb of a predetermined wavelength emitted by the semiconductor laser elements 41a and 41b, respectively, pass through pre-polarization optical systems 42a and 42b, respectively. The laser beams La and Lb are then guided to a polarizing device 43 having a polygon mirror 43a. That is, the laser beam La passes through the pre-polarization optical system 42a, a half mirror 42c, and a cylinder lens 42d that converges the light in the sub-scanning direction. The laser beam La is guided to the polarizing device 43 having the polygon mirror 43a. Further, the laser beam Lb passes through the pre-polarization optical system 42b and is then reflected by the half mirror 42c. On the other hand, the laser beam Lb reflected by the half mirror 42c passes through the cylinder lens 42d and is then guided to an arbitrary face of the polygon mirror 43a.

The cross sections of beam spots of the laser beams La and Lb from the semiconductor laser elements 41a and 41b, respectively, are adjusted to predetermined shapes by the pre-polarization optical systems 42a and 42b. The pre-polarization optical systems 42a and 42b comprise finite focus lenses 44a and 44b, respectively, that provide predetermined convergent nature to divergent laser beams from the semiconductor laser elements 41a and 41b; diaphragms 45a and 45b, respectively, that adjust the cross sections of the laser beams having passed through the finite focus lenses 44a and 44b, to predetermined shapes; and galvanomirrors 46a and 46b, respectively, which bend the laser beams having passed through the diaphragms 45a and 45b and then guide them to the half mirror 42c and which adjust the positions of the two laser beams La and Lb so as to set the interval between the beams in the sub-scanning direction at a predetermined value.

The finite focus lenses 44a and 44b may be, for example, aspherical glass lenses or single lenses each formed by sticking an ultraviolet-setting plastic aspherical lens to a spherical glass lens. Further, the galvanomirrors 46a and 46b each include an optical-path changing device that can finely and arbitrarily vary the direction in which the laser beam is reflected.

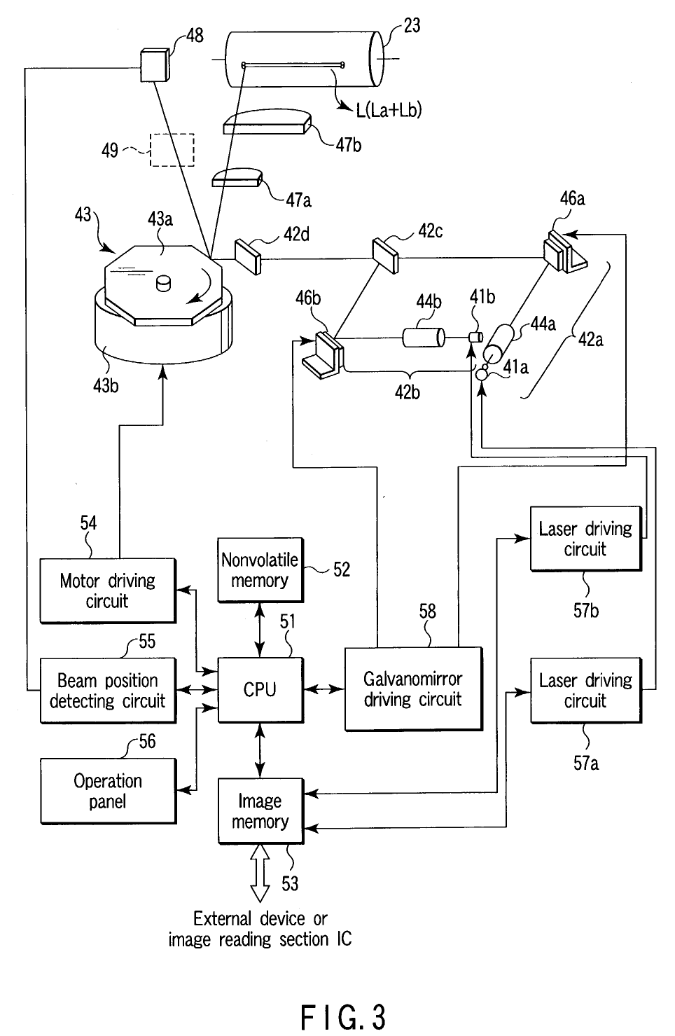

The individual mirror faces of the galvanomirrors 46a and 46b have their inclinations, i.e. (reflection) angles arbitrarily and independently varied by a galvanomirror driving circuit 58, described below with reference to FIG. 3.

Further, the laser beam La from the first laser element 41a reflected by the galvanomirror 46a and the laser beam Lb from the second laser element 41b reflected by the galvanomirror 46b are integrated into synthesized laser beams (La+Lb) at the parallel direction by the half mirror 42c. The synthesized laser beams appear single as viewed from a planar direction (main scanning direction) as shown in FIG. 2, and have a predetermined interval between themselves in the sub-scanning direction, which is orthogonal to the parallel direction. The cylinder lens 42d further provides the synthesized laser beams (La+Lb) with convergent nature in the sub-scanning direction and then guides them to the polarizing device 43. The polarizing device 43 is a rotating polygon mirror in which a regular polyhedral polygon mirror 43a is rotated at a predetermined speed by a motor 43b, the polygon mirror 43a having eight planar reflection mirrors formed on its outer peripheries.

The following components are arranged between the polarizing device 43 and an image surface, a design focal plane located so as to correspond to the exposure position X in the outer periphery of the photosensitive drum 23: a post-polarization optical system 47 including a doublet lens system including a first and second image forming lenses 47a and 47b that provide predetermined optical characteristics to synthesized laser beams L (La+Lb) polarized (scanned) by each reflecting surface of the polygon mirror 43a of the polarizing device 43 to travel in predetermined directions; a beam position detecting sensor 48 that detects that the leaser beams La and Lb of the laser beam L (La+Lb) emitted by the second image forming lens 47b of the post-polarization optical system 47 have reached predetermined positions located in front of an area in which an image is written (passage timing), the sensor 48 also detecting these predetermined positions; a reflecting mirror 49 arranged between the post-polarization optical system 47 and the beam position detecting sensor 48 to reflect the synthesized laser beams L (La+Lb) toward the beam position detecting sensor 48; and other components.

Now, with reference to FIG. 3, description will be given of an example of a control system for the multibeam exposure device shown in FIG. 2.

As shown in FIG. 3, a CPU (Central Processing Unit) 51 provides such control that data is written to and/or read from a nonvolatile memory 52 or an image memory 53. A motor driving circuit 54 rotates the motor 43b of the polarizing device 43 at a predetermined speed. A beam position detecting circuit 55 detects the positions of laser beams on the basis of a detection signal from the beam position detecting sensor 48.

Laser driving circuits 57a and 57b cause the semiconductor laser elements 41a and 41b to output laser beams of a predetermined wavelength. Further, a galvanomirror driving circuit 58 provided with a D/A converter sets the inclinations of mirror faces of the galvanomirrors 46a and 46b. The galvanomirror driving circuit 58 can control driving of individual mirrors 100 according to different instruction values for the galvanomirrors 46a and 46b.

The semiconductor laser elements 41a and 41b emit the laser beams La and Lb having their light intensities changed so as to correspond to image data stored in the image memory 53.

The laser beam emitted by each of the laser elements 41a and 41b has an intensity lower than that sufficient to form a latent image on the photosensitive drum 23. This is because the magnitude of a laser driving current from each of the laser driving circuits 57a and 57b, the magnitude corresponding to control carried out by the CPU 51, is kept small until the rotation speed of the polygon mirror 43a reaches a predetermined value.

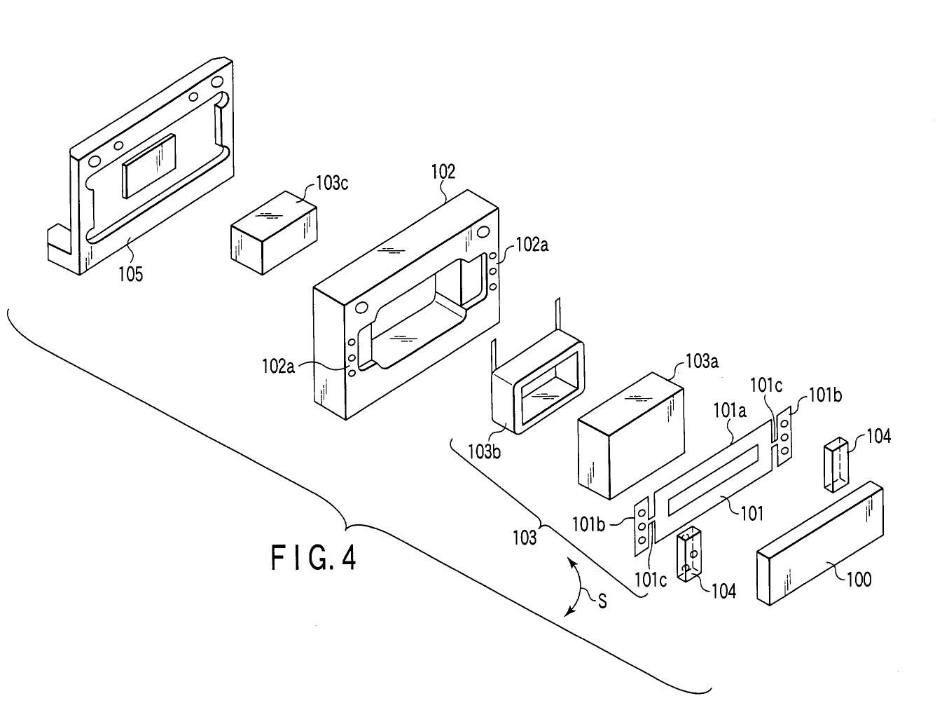

As shown in FIG. 4, the galvanomirrors 46a and 46b each have a plate spring 101 that holds the mirror 100 so that its angle can be changed, and a frame 102 that supports the plate spring 101 so as to be movable in an arbitrary direction.

The plate spring 101 is provided with a bobbin 103a constituting a thrust generating section 103 that generates force required to move the plate spring 101, and a coil 103b housed inside the bobbin 103a. The plate spring 101 is composed of beryllium copper, spring stainless steel SUS 304, or the like.

The plate spring 101 is provided with a support surface 101a that supports the mirror 100, holding surfaces 101b utilized to connect to the frame 102, and a torsion bar portion 101c as a torsion deformation portion that connects the holding surfaces 101b and the support surface 101a together. The mirror 100 can be rotated in the direction of an arrow S by twisting the torsion bar 101c in a predetermined direction.

Further, the plate spring 101 is fixed, using screws, to threaded holes 102a formed in the frame 102, together with spring pressers 104 formed of, for example, resin.

A magnet 103c is housed inside the coil 103b to provide a magnetic field required to generate force that rotationally moves the plate spring 101 if a current flows through the coil 103b. The magnet 103c is fixed to a central portion of a fixing plate 105 and thus to a predetermined position of the exposure device 21. The frame 102 supports the plate spring 101 that holds the mirror 100, and is mounted integrally with the fixing plate 105.

Further, the bobbin 103a in which the magnet 103c and the coil 103b are housed is spaced from the frame 102 by a predetermined distance. A damping material such as silicone gel is filled into the gap between the frame 102 and the bobbin 103a to prevent the mirror 100 from being vibrated by disturbance vibration or the like. The frame 102 functions as a yoke constituting a magnetic circuit for a magnetic line of force from the magnet 103c.

When the CPU 51 supplies, for example, an 8-bit instruction value to the galvanomirror driving circuit 58, the galvanomirror driving circuit 58 supplies a current of a predetermined polarity to the coils 103b of the galvanomirrors 46a and 46b. Magnetic force generated between the coil 103b and the magnet 103c twists the support surface 101a of the plate spring 101 to rotationally move the mirror 100 in the direction of the arrow S according to an instruction value. The rotational movement of the mirror 100 adjusts the directions of laser beams reflected by a mirror face, i.e. their positions in the sub-scanning direction. The angle at which the mirror 100 is located is maintained by retaining the magnitude of a current supplied to the coil 103b.

Further, the angle through which the mirror 100 is rotationally moved is determined by an instruction value from the CPU 51. An 8-bit instruction value can vary the angle of the mirror 100 through 256 levels.

Now, with reference to FIG. 6, description will be given of the characteristics of detecting surface of the beam position detecting sensor incorporated into the exposure device shown in FIG. 2.

The beam position detecting sensor 48 has a square light receiving surface composed of a sensor 48A and a sensor 48B. As shown in FIG. 6, the sensor 48A and 48b respectively has a light receiving surface (detecting areas) and each is a right-angled triangle. The detecting area of the sensor 48B has a lateral-side (longer side) being arranged parallel with a lateral-side of the detecting area of the sensor 48A. The sensors 48A and 48B are formed to have substantially the same area. Accordingly, the sensors 48A and 48B output a current of the same magnitude when light of the same intensity passes through their centers. Further, before shipment, a correction amount for output from one of the sensors is set and stored in an NVRAM.

If a laser beam such as the one shown in FIG. 6 passes through the light receiving surface, the sensor 48A receives this laser beam for a longer time, while the sensor 48B receives it for a shorter time. This enables the detection of the position on the light receiving surface through which the laser beam has passed.

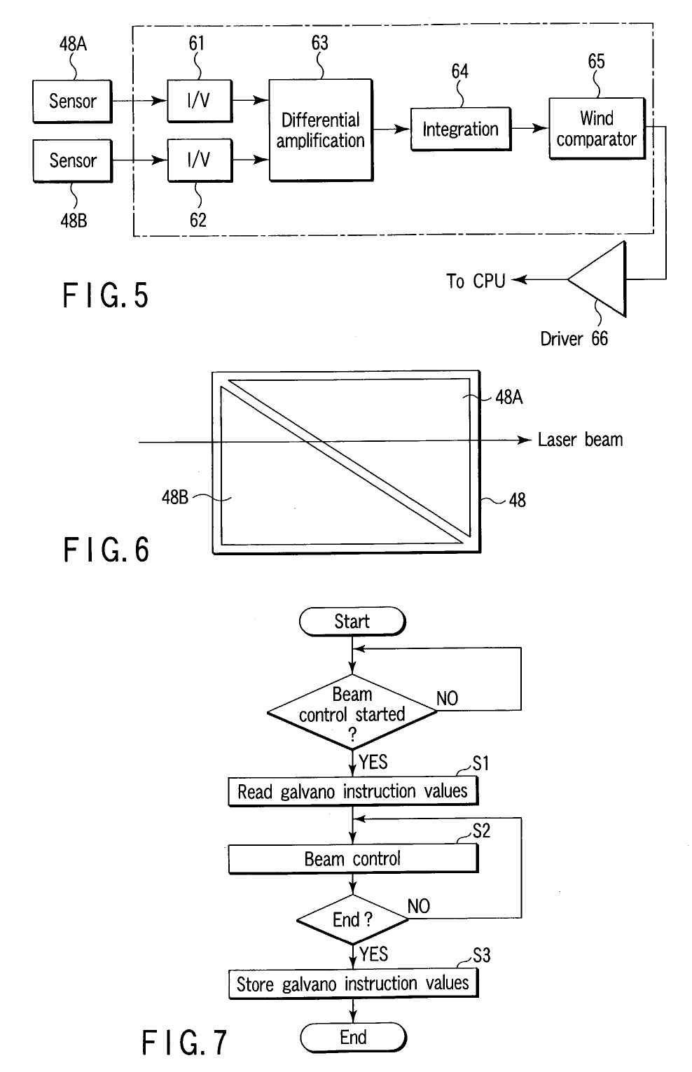

Specifically, as shown in FIG. 5, a beam position detecting circuit 55 has a current/voltage converting circuit 61 that converts an output from the sensor 48A into a voltage signal, and a current/voltage converting circuit 62 that converts an output from the sensor 48B into a voltage signal. The voltage signals from the current/voltage converting circuits 61 and 62 are amplified by a differential amplifier 63. The differential amplifier 63 then outputs the difference between these voltage signals. The output from the differential amplifier 63 is integrated by an integrating circuit 64. An output from the integrating circuit 64 is compared with a set value by a wind comparator 65 and then outputted to a driver 65. An output from the beam position detecting circuit 55 is binarized by the driver 66 and then supplied to the CPU 51 as sub-scanning position detection data. The current/voltage converting circuits 61 and 62, the differential amplifier 63, the integrating circuit 64, and the wind comparator 65 are each composed of an ASIC.

When a predetermined current is supplied to each section, not described in detail, before the multibeam exposure device 21 carries out exposure (i.e. when the power supply to each section is turned on), the plate spring 101 holding the mirror 100 is fixed at a position where it is balanced owing to its own weight. This is because no current is supplied to the coil 103 of the galvanomirror 46a or 46b. In this condition, when the polygon mirror 43a is rotated to cause the semiconductor laser elements 41a and 41b to emit the laser beams La and Lb, respectively, the beams La and Lb are reflected by the mirrors 100 of the galvanomirrors 46a and 46b, respectively. The laser beams La and Lb are collected on that part of surface of the photosensitive drum 23 which is off a predetermined position in the sub-scanning direction.

The sensors 48A and 48B of the position detecting sensor 48 detect the positions on themselves through which the laser beams La and Lb have passed.

Those positions on the sensors 48A and 48B of the beam position detecting sensor 48 through which the laser beam passes are detected for each of the laser beams La and Lb. That is, the adjusted semiconductor laser elements 41a and 41b are not simultaneously but separately operated so that each of the emitted laser beams La and Lb can have its position detected.

Further, it is impossible for the sensors 48A and 48B of the beam position detecting sensor 48 to detect the positions of the lasers La and Lb if these beams do not pass through the sensors. Much labor and time is required to make such adjustment that the laser beams La and Lb can pass through the sensors 48A and 48B. Even if the laser beams La and Lb pass through the sensors 48A and 48B of the beam position detecting sensor 48, when the position on the sensor 48A through which the laser beam passes markedly deviates from the position on the sensor 48B through which the laser beam passes, much labor and time is required to make such adjustment that the laser beams La and Lb pass through a predetermined position.

When the power supply to the multibeam exposure device 21 is turned off, positional information on the laser beams La and Lb detected through the adjustment is stored in the nonvolatile memory (NVRAM) 52 by the CPU 51 as instruction values supplied to the galvanomirror driving circuit 58 by the CPU 51.

When the predetermined current is supplied to each section, not described in detail, before the multibeam exposure device 21 carries out exposure (i.e. when the power supply to each section is turned on), the CPU 51 reads the galvano instruction values stored in the nonvolatile memory 52 as positional information on the laser beams La and Lb passing through the sensors 48A and 48B of the beam position detecting sensor 48 last time the power is turned off. The CPU 51 then controls the galvanomirror driving circuit 58 on the basis of these galvano instruction values.

Now, with reference to FIG. 7, detailed description will be given of a step of adjusting the angles of the galvanomirrors using the beam position detecting sensor having the detecting surface shown in FIG. 6.

As shown in FIG. 7, when the predetermined current is supplied to each section, not described in detail, before the multibeam exposure device 21 carries out exposure (i.e. when the power to each section is turned on), the CPU 51 determines that the semiconductor laser elements 41a and 41b will emit the laser beams La and Lb, respectively. Then, at step S1, the CPU reads the galvano instruction values (positional information on the laser beams La and Lb passing through the sensors 48A and 48B of the beam position detecting sensor 48 last when the predetermined current is cut off (i.e. when the power to each section is turned off), the current being supplied to each section, not described in detail, before the multibeam exposure device 21 carries out exposure). The read galvano instruction values are provided to the galvanomirror driving circuit 58. The coils 103b of the galvanomirrors 46a and 46b are supplied with respective predetermined currents (driving control means).

Subsequently, at step S2, the semiconductor laser elements 41a and 41b are driven to emit the beams La and Lb. On the basis of the laser beams La and Lb incident on the sensors 48A and 48B of the beam position detecting sensor 48, the galvanomirrors 46a and 46b can adjust the directions in which the laser beams La and Lb from the semiconductor laser elements 41a and 41b, respectively, are reflected.

The predetermined current is cut off (i.e. when the power to each section is turned off), the current being supplied to each section, not described in detail, before the multibeam exposure device 21 carries out exposure. Then, at step S3, the CPU 51 stores the last galvano instruction values supplied to the galvanomirror driving circuit 58, in the nonvolatile memory 52 to end processing (storage control means).

With this configuration, if the predetermined current is supplied to each section, not described in detail, before the multibeam exposure device 21 carries out exposure, then the CPU 51 can read the last galvano instruction values (supplied last during step S2) from the nonvolatile memory 52 and adjust the galvano mirror driving circuit 58 on the basis of these galvano instruction values.

Now, description will be given of a mode in which the laser beams La and Lb are adjusted according to the present embodiment.

If the position of the laser beam La is adjusted, the predetermined current is supplied only to the semiconductor laser element 41a, with the laser beam La directly reflected by the polygon mirror 43a. The laser beam La reflected by the galvanomirror 46a is reflected by the polygon mirror 43a. Then, the post-polarization optical system 47 expose the photosensitive drum 23 to the laser beam La. Further, the laser beam La from the polygon mirror 43a is incident on the reflected beam position detecting sensor 48.

The mirror 100 of the galvanomirror 46a is located at a predetermined angle according to the last galvano instruction values. Thus, the laser beam La from the semiconductor laser element 41a can reliably pass through the sensors 48A and 48B of the beam position detecting sensor 48. Further, the positions on the sensors 48A and 48B through which the laser beam La passes do-not deviate from the desired ones.

Thus, fine-tuning the galvanomirror 46a serves to reduce the time required to adjust the laser beam La to the desired position.

Once the laser beam La is completely adjusted, the predetermined current is supplied only to the semiconductor laser element 41b. The laser beam Lb is directly reflected by the polygon mirror 43a. Then, the post-polarization optical system 47 expose the photosensitive drum 23 to the laser beam Lb. Further, the laser beam Lb from the polygon mirror 43a is incident on the beam position detecting sensor 48.

The mirror 100 of the galvanomirror 46b is located at a predetermined angle according to the last galvano instruction values. Thus, the laser beam Lb from the semiconductor laser element 41b can reliably pass through the sensors 48A and 48B of the beam position detecting sensor 48. Further, the positions on the sensors 48A and 48B through which the laser beam Lb passes do not deviate from the desired ones.

Thus, fine-tuning the galvanomirror 46b serves to reduce the time required to adjust the laser beam Lb to the desired position.

To form an image, the laser beams La and Lb are simultaneously emitted by the semiconductor laser elements 41a and 41b, respectively. The laser beams La and Lb are simultaneously collected at the exposure position X on the photosensitive drum 23. In this case, the interval in the sub-scanning direction is 42.3 μm with a resolution of 600 dpi.

In the description of this embodiment, the laser beams are used as light beams. However, of course, the exposure device of the present invention is not limited to this aspect.

Further, in the description of this embodiment, the multibeam exposure device is used. It should be appreciated that the optical scanning device of the present invention is not limited to the multibeam exposure device.

As described above in detail, the present invention can provide a beam position adjusting method and device for an optical scanning apparatus which enables, even when reset during standby, the angles of mirror faces of the galvanomirrors to be easily adjusted to reduce the time required to adjust the positions of light beams.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A beam position adjusting method for adjusting angles of surfaces of galvanomirrors by supplying predetermined power with respect to positions which detect positions on the sensors through which laser beams to be scanned pass so that the passage positions of the light passing through the sensors from driving control means to the galvanomirrors comprising:
storing a value of power supplied to the galvanomirrors as information on the angles of the galvanomirrors obtained while the driving control means is turned off; and
reading the value of power supplied to the galvanomirrors on the basis of the information stored within the storing and supplying a predetermined power to the galvanomirrors.

2. An optical scanning apparatus using galvanomirrors each having a mirror face the angle of which can be changed by supplying power to the galvanomirror, the apparatus also using sensors which detects positions on the sensors through which laser beams to be scanned pass so that the passage positions of the light passing through the sensors can be adjusted by changing the angles of mirror faces of the galvanomirrors, the apparatus comprising:
a storage section which stores the value of power supplied to the galvanomirrors as information on mirror face angles at which the galvanomirrors are located;
storage control means for causing the storage section to store the information on the angles of the mirror faces while not supplying power to the galvanomirrors; and
driving control means for reading the information on the angles of the mirror faces stored in the storage section while supplying the power to the galvanomirrors and for displacing the galvanomirrors on the basis of the information on the angles of the mirror faces.

3. An optical scanning apparatus comprising:
a plurality of light sources each of which emits light of a predetermined wavelength;
optical-path aligning means for positioning light beams from the respective light sources at predetermined intervals in a first direction to synthesize the light beams so that the beams appear single;
polarizing means for polarizing the light beams form the respective light sources synthesized by the optical-path aligning means so that the beams travel along a second direction orthogonal to the first direction;
displacement detecting means for detecting displacement of the optical-path aligning means with respect to the first direction by detecting at least one of the light beams from the respective light sources which are polarized by the polarizing means;
a storage section which stores the displacement of the optical-path aligning means detected by the displacement detecting means; and
a driving means for energizing the optical-path aligning means and for aligning the displacement of the optical-path aligning means so as to provide such light beams that the light beams from the respective light sources can be considered to be single.

4. The optical scanning apparatus according to claim 3, wherein the optical-path aligning means includes mirrors formed to operate with respect to the first direction to reflect the light beams from the respective light sources, and angles at which the mirrors reflect the light beams from the respective light sources are defined by the driving means by changing angles of reflecting surfaces of the mirrors.

5. The optical scanning apparatus according to claim 3, wherein the optical-path aligning means includes an electromagnetic driving circuit which can urge the mirrors through arbitrary angles with respect to the first direction.

6. The optical scanning apparatus according to claim 5, wherein the driving means supplies predetermined power to the electromagnetic driving circuit on the basis of the magnitude and direction of displacement of the optical-path aligning means with respect to the first direction which displacement is detected by the displacement detecting means.

7. The optical scanning apparatus according to claim 6, wherein when a power supply to the optical scanning apparatus is turned on, the driving means urges the electromagnetic driving circuit on the basis of last instruction values stored in the storage section.

8. The optical scanning apparatus according to claim 7, wherein the driving means urges the electromagnetic driving circuit of the optical-path aligning means on which the light beams from the plurality of light sources are incident, according to an order of the light beams outputted by the light sources in a predetermined order in an adjustment mode.

9. The optical scanning apparatus according to claim 6, wherein the driving means causes the storage section to store the instruction values used to urge the electromagnetic driving circuit, while the electromagnetic driving circuit is not urged, and the driving means urges the electromagnetic driving circuit on the basis of the instruction values stored while the electromagnetic driving circuit is being urged.

10. The optical scanning apparatus according to claim 3, wherein the displacement detecting means is a horizontal synchronization detector which defines output timings for the respective light beams polarized by the polarizing means to travel in the first direction, when an image signal is outputted.

11. The optical scanning apparatus according to claim 3, wherein the displacement detecting means is an optical detecting element having two light receiving surfaces, and detects the displacement of the optical-path aligning means with respect to the first direction on the basis of a light receiving time required by a light beam from an arbitrary light source polarized by the polarizing means to pass through each of the light receiving surfaces.

12. The optical scanning apparatus according to claim 11, wherein the light receiving surfaces have longer sides arranged opposite each other.
